(19) United States
(12) Patent Application Publication
(10) Pub. No.: US 2025/0217555 A1
(43) Pub. Date: Jul. 3, 2025

(54) DATA ACQUISITION METHOD, DATA ACQUISITION DEVICE, AND PROGRAM

(71) Applicant: SEIKO EPSON CORPORATION, Tokyo (JP)

(72) Inventor: Michiko KAWAJI, KAI-SHI (JP)

(21) Appl. No.: 18/962,590

(22) Filed: Nov. 27, 2024

(30) Foreign Application Priority Data
Nov. 30, 2023 (JP) 2023-202442

(51) Int. Cl. G06F 30/27

(52) U.S. Cl. CPC G06F 30/27

(57) ABSTRACT

The data acquisition method includes a first step for acquiring input data including at least one of shock response data that relates to a shock response spectrum and stress-strain data that relates to a stress-strain curve, and a second step for executing at least one of (i) a first acquisition step for acquiring, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition step for acquiring, using second association data in which shape data of the cushioning material and the stress-strain curve of the cushioning material are associated, second objective data representing the shape data corresponding to the input stress-strain data.

The present application is based on, and claims priority from JP Application Serial Number 2023-202442, filed Nov. 30, 2023, the disclosure of which is hereby incorporated by reference herein in its entirety.

### BACKGROUND

### 1. Technical Field

The present disclosure relates to a data acquisition method, a data acquisition device, and a program.

### 2. Related Art

JP-A-2022-191849 discloses a technique for improving the shock-absorbing performance of a shock cushioning material. In the technology disclosed in JP-A-2022-191849, the shock cushioning material is configured so that, in a stress-strain curve when the shock cushioning material is compressed, a so-called plateau region, where stress remains substantially constant even as strain increases, is widened.

In recent years, protection targets to be protected by cushioning materials and usage situations in which cushioning materials are used have become more diverse, and there is a growing demand for the design of a variety of cushioning materials. Therefore, there is need for technologies that makes it easier to design desired cushioning materials.

### SUMMARY

According to a first aspect of the present disclosure, a data acquisition method is provided. This data acquisition method includes a first step for acquiring input data including at least one of shock response data that relates to a shock response spectrum and stress-strain data that relates to a stress-strain curve; and a second step for executing at least one of (i) a first acquisition step for acquiring, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition step for acquiring, using second association data in which shape data of the cushioning material and the stress-strain curve of the cushioning material are associated, second objective data representing the shape data corresponding to the input stress-strain data.

According to a second aspect of the present disclosure, a data acquisition device is provided. This data acquisition device includes an input data acquisition section that acquires input data including at least one of shock response data that relates to a shock response spectrum and stress-strain data that relates to a stress-strain curve; and an objective data acquisition section that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.

According to a third aspect of the present disclosure, a non-transitory computer recording medium storing a program to be executed by a computer is provided. The program includes a function that acquires input data including at least one of shock response data that relates to a shock response spectrum and stress-strain data that relates to a stress-strain curve; and a function that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.

### BRIEF DESCRIPTION OF THE DRAWINGS

FIG. 1 is a block diagram showing a schematic configuration of a data acquisition device according to a first embodiment.

FIG. 2 is a conceptual diagram that explains an example of protection targets and cushioning materials.

FIG. 3 is a diagram that explains an example of shock simulation.

FIG. 4 is a diagram that explains a relationship between stress-strain curves, acceleration waveforms, and shock response spectra.

FIG. 5 is a flowchart of a data acquisition process in the first embodiment.

FIG. 6 is a block diagram showing a schematic configuration of a data acquisition device according to a second embodiment.

FIG. 7 is a flowchart of a data acquisition process in the second embodiment.

FIG. 8 is a block diagram showing a schematic configuration of a data acquisition device according to a third embodiment.

FIG. 9 is a flowchart of a data acquisition process in the third embodiment.

FIG. 10 is a flowchart of a data acquisition process in a fourth embodiment.

FIG. 11 is a flowchart of a data acquisition process in a fifth embodiment.

### DESCRIPTION OF EMBODIMENTS

### A. First Embodiment

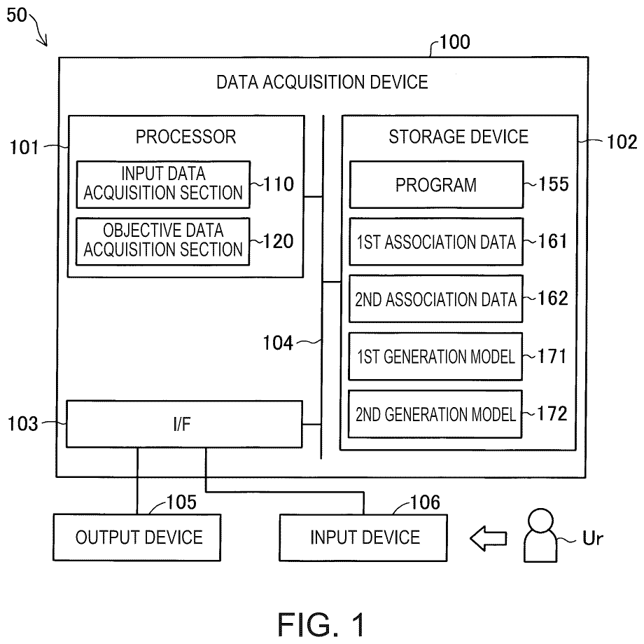

FIG. 1 is a block diagram showing a schematic configuration of a data acquisition device 100 according to a first embodiment. The data acquisition device 100 is used to design a cushioning material to protect an object. Specifically, the data acquisition device 100 is used to acquire data that is used in the design of cushioning material. In this embodiment, the data acquisition device 100 is used in a design system 50 that designs a cushioning material. Hereinafter, an object protected by the cushioning material is also referred to as a protection target.

The protection target of the cushioning material may be, for example, various products or living body such as human. In this embodiment, the protection target is a product. The product may be any product, for example, it may be various devices such as a printing device, a projection device, a three-dimensional molding device, and an injection molding device, or it may be various components. The cushioning material may protect the protection target from shock, for example, by being accommodated together with the protection target in a container for accommodating the protection target. The cushioning material may also be designed as a container, an outer shell, protective gear, a base, or the like having a function of protecting the protection target from shock.

The data acquisition device 100 in this embodiment is configured by a computer including one or more processors 101, a storage device 102, an input and output interface 103, and an internal bus 104. The processor 101, the storage device 102, and the input and output interface 103 are connected via the internal bus 104 so that they can communicate in both directions. An output device 105 and an input device 106 are connected to the input and output interface 103. The storage device 102 according to this embodiment stores a program 155, first association data 161, and second association data 162.

The first association data 161 is data that an acceleration waveform representing shock acceleration of a protection target and a shock response spectrum (SRS) of the protection target are associated. The acceleration waveform is waveform data that represents, in a time series, the acceleration that occurs in the protection target when shock is applied to the protection target. The shock response spectrum is spectrum data that represents the acceleration that occurred in the object when shock is applied to the object, for each natural frequency of elements included in the object. Specifically, the shock response spectrum is data in which the maximum value of the shock acceleration is plotted for each natural frequency of elements included in the object. The acceleration waveform and the shock response spectrum included in the first association data 161 are acquired, for example, by analyzing behavior of the protection target when shock is applied to the protection target based on simulations or experiments. Hereinafter, a simulation about the behavior of a protection target when shock is applied to the protection target is also referred to as a shock simulation. In the first association data 161 in the present embodiment, the acceleration waveform and the shock response spectrum based on the same shock simulation are associated with each other.

The second association data 162 is data in which shape data of a cushioning material and a stress-strain curve of the cushioning material are associated. The shape data is, for example, two dimensional or three-dimensional computer aided design (CAD) data that represents the shape of the cushioning material. The stress-strain curve is data that represents a relationship between stress and strain of a cushioning material when the cushioning material is compressed. In the second association data 162 in the present embodiment, the shape data and the stress-strain curve of the same cushioning material are associated with each other.

A first generation model 171 is a machine learning model that has been subjected to machine learning using the first association data 161 as learning data. Hereinafter, the learning data used for learning of the first generation model 171 is referred to as first learning data. The first generation model 171 in the present embodiment has been trained by supervised learning. In the present embodiment, the first learning data is teacher data that includes a plurality of shock response spectra as training data and that includes acceleration waveforms associated with each of the shock response spectra as a ground truth label. When shock response data is input to the first generation model 171, the first generation model 171 generates and outputs an acceleration waveform corresponding to the input shock response data. Specifically, the first generation model 171 is generated as a regression model that estimates a function representing an acceleration waveform according to the shock response data input to the first generation model 171. The first generation model 171 is constituted, for example, by a convolutional neural network (CNN). In the machine learning for the CNN as the first generation model 171, for example, using the error backpropagation method, the first generation model 171 is trained so that an error between an acceleration waveform generated by the first generation model 171 and an acceleration waveform as the ground truth label becomes small. In other embodiments, the first generation model 171 may be constituted by a neural network other than the CNN, or may be constituted by a support vector machine (SVM) or a decision tree, for example. In addition, the first generation model 171 may be trained not only by supervised learning but also by unsupervised learning or reinforcement learning, for example.

A second generation model 172 is a machine learning model that has been subjected to machine learning using the second association data 162 as learning data. Hereinafter, the learning data used for learning of the second generation model 172 is referred to as second learning data. The second generation model 172 in the present embodiment has been trained by supervised learning. In the present embodiment, the second learning data is teacher data that includes a plurality of stress-strain curves as training data and that includes shape data associated with each of the stress-strain curves as a ground truth label. When stress-strain data is input to the second generation model 172, the second generation model 172 generates and outputs shape data corresponding to the input stress-strain data. Specifically, the second generation model 172 is generated as a regression model that estimates a function representing shape data according to the stress-strain data input to the second generation model 172. The second generation model 172 is constituted, for example, by a neural network such as a CNN similarly to the first generation model 171. In the machine learning of the CNN as the second generation model 172, for example, using the error backpropagation method, the second generation model 172 is trained so that an error between shape data generated by the second generation model 172 and shape data as the ground truth label becomes small. In other embodiments, the second generation model 172 may be constituted, for example, by an SVM or a decision tree, or may be trained by unsupervised learning or reinforcement learning.

The processor 101 executes the program 155 stored in the storage device 102 to realize various functions including functions as an input data acquisition section 110 and an objective data acquisition section 120, and including a function of executing a data acquisition process (to be described later).

The input data acquisition section 110 acquires input data entered by the user. The input data includes at least one of the shock response data and the stress-strain data. The shock response data is data relating to the shock response spectrum. As the shock response data, for example, data is input that relates to a shock response spectrum corresponding to the cushioning material desired to be designed, and the shock response spectrum corresponding to the protection target of the cushioning material. The shock response data may, for example, be represented as a shock response spectrum or as a feature value of the shock response spectrum. The stress-strain data is data relating to the stress-strain curve. As the stress-strain data, for example, data is input that relates to a stress-strain curve corresponding to the cushioning material desired to be designed. The stress-strain data may, for example, be represented as a stress-strain curve or a feature value of the stress-strain curve. The input data acquisition section 110 in the present embodiment is configured to be able to acquire both the shock response data and the stress-strain data as input data.

In this embodiment, the input data acquisition section 110 acquires input data entered by the user Ur via the input device 106. The input device 106 is configured with a mouse or keyboard, for example. The user Ur can input desired shock response data and desired stress-strain data to the data acquisition device 100 via the input device 106. In the present embodiment, both the shock response data and the stress-strain data can be input to the input device 106.

The objective data acquisition section 120 executes at least one of a first acquisition process and a second acquisition process. The first acquisition process is a process that acquires a first objective data using the first association data 161. The first objective data is data representing an acceleration waveform corresponding to the shock response data acquired by the input data acquisition section 110. The second acquisition process is a process that acquires a second objective data using the second association data 162. The second objective data is data representing shape data corresponding to the stress-strain data acquired by the input data acquisition section 110. Hereinafter, in cases where no distinction is made between the first objective data and the second objective data, they are simply referred to as objective data.

The output device 105 outputs the objective data acquired by the objective data acquisition section 120. The output device 105 in the present embodiment is configured as a display device that outputs the objective data as visual information. The display device is configured, for example, with a liquid crystal panel or an organic electroluminescent panel. Note that the output device 105 as a display device may be configured, for example, as a touch panel that can accept touch operations from the user Ur. In this case, the output device 105 may also function as the input device 106, for example. In other embodiments, the output device 105 may be configured as, for example, a device that outputs the objective data by transmitting the objective data to an external computer or a recording medium.

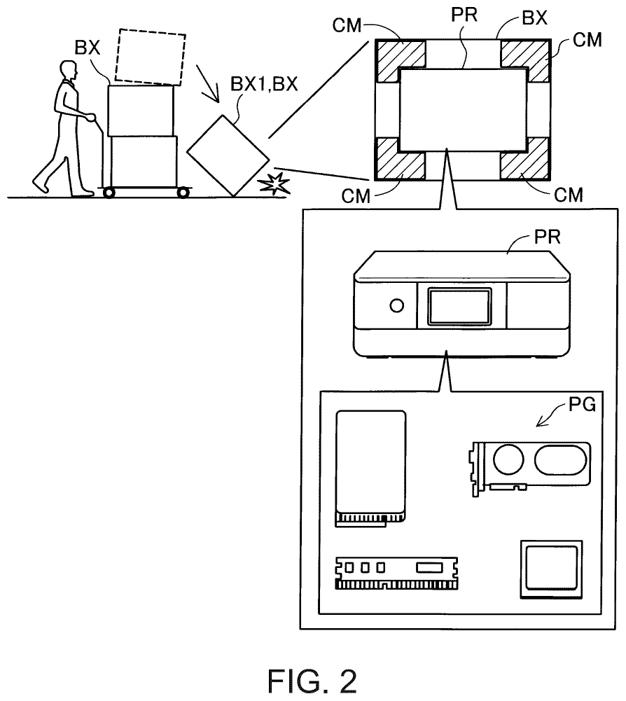

FIG. 2 is a diagram that explains an example of protection targets and cushioning materials. FIG. 2 shows a state in which a box-like container BX containing a product PR is being transported. In the container BX, in addition to the product PR, cushioning materials CM that protect the product PR from shock are provided. In other words, in the example of FIG. 2, the protection target of the cushioning materials CM is the product PR. In the example of FIG. 2, the product PR includes a group of parts PG, which is configured from various components. For example, if the product PR is an electronic device such as a printing device or a projection device, the group of parts PG includes various electronic components and structural components. Note that the cushioning materials CM are hatched in FIG. 2.

FIG. 2 also shows how the container BX1 falls during transportation. Due to a fall of the container BX1, the product PR accommodated in the container BX1 is subjected to shock from the ground due to the fall, for example. The cushioning materials CM are designed to suppress or prevent damage or breakage of the product PR due to such shock. Specifically, the cushioning materials CM are designed to reduce shock acceleration that occurs in the product PR due to the shock.

It is desirable that the cushioning materials CM are designed to suppress or prevent damage or breakage caused by the shock acceleration to each component included in the group of parts PG of the product PR. Here, each component included in the group of parts PG is most likely to be damaged when shock acceleration occurs that is the same vibration frequency as the natural frequency of each component. Therefore, it is desirable that the cushioning materials CM will be designed so that, when the product PR is subjected to the shock, shock acceleration of the same vibration frequency as the natural frequency of each component caused by the shock is less than an acceleration threshold that could damage each component.

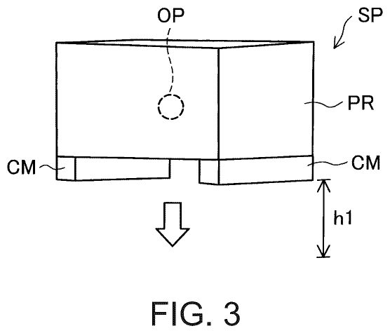

FIG. 3 is a diagram that explains an example of shock simulation in this embodiment. The shock simulation is performed to acquire an acceleration waveform and a shock response spectrum. The shock simulation is executed, for example, using analysis software that dynamically analyzes the behavior of the product PR when the product PR is subjected to shock. In the shock simulation, for example, at least a part of non-linear structural analysis, linear structural analysis, non-linear structural analysis, eigenvalue analysis, and frequency response analysis is executed. As a method of spatial discretization in the shock simulation, for example, a finite element method, a boundary element method, or a discrete element method can be used. Time evolution in the shock simulation can be calculated, for example, by dynamic explicit method.

FIG. 3 shows a scene in which a drop test simulation is performed, where a sample SP is dropped to the ground. In the drop test simulation, shock acceleration that occurs in the sample SP when the sample SP is dropped and then hits the ground, is observed at a predetermined observation point OP. The observation point OP is, for example, the center of gravity of the product PR. In the example of FIG. 3, the sample SP is the product PR supported by cushioning materials CM from below. In the example of FIG. 3, the cushioning materials CM are designed as cushioning materials that protect the product PR from shock due to falling. In the simulation of FIG. 3, simulation conditions are set, for example, so as to include dimensions and weight of the product PR, dimensions and weight of the cushioning materials CM, a relative position between the product PR and the cushioning materials CM, a height hl of the sample SP from the ground, and the stress-strain curve of the cushioning materials CM. The height hl is desirably determined, for example, according to actual transport conditions under which the product PR will be transported. Transport condition means, for example, a type of transport equipment or transport device that is used to transport the product PR, dimensions of a container that accommodates the product PR during transport, and a height at which the product PR is placed during transport. The stress-strain curve of the cushioning material CM is acquired, for example, based on an experiment or simulation in which the cushioning material CM is compressed.

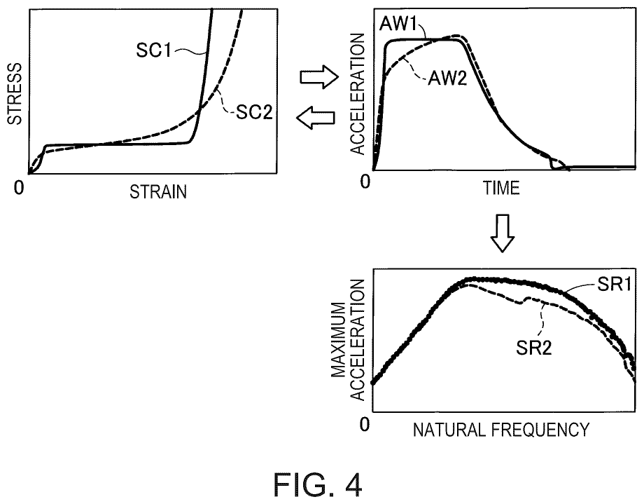

FIG. 4 is a diagram that explains a relationship between a stress-strain curve, an acceleration waveform, and a shock response spectrum. FIG. 4 shows an example of acceleration waveforms that can be acquired by the shock simulation and an example of shock response spectra. Note that a “maximum acceleration” in FIG. 4 means the maximum value of the shock acceleration for each natural frequency. FIG. 4 shows an example of stress-strain curves that will be used as simulation conditions of the shock simulation. Specifically, in FIG. 4, a first waveform AW1 for a first sample and a second waveform AW2 for a second sample are shown as examples of the acceleration waveforms. The first sample and the second sample are different samples SP. In FIG. 4, a first spectrum SRI for the first sample and a second spectrum SR2 for the second sample are also shown as examples of the shock response spectra. In FIG. 4, a first curve SC1 for a cushioning material included in the first sample and a second curve SC2 for a cushioning material included in the second sample are also shown as examples of the stress-strain curves.

In the shock simulation in the present embodiment, acceleration waveforms such as the first waveform AW1 and the second waveform AW2 are acquired as simulation results. Note that between a shock simulation to acquire the first waveform AW1 and a shock simulation to acquire the second waveform AW2, only the stress-strain curve is different in the simulation conditions. The first spectrum SR1 is calculated based on the first waveform AW1. The second spectrum SR2 is calculated based on the second waveform AW2. The first curve SC1 corresponds to a stress-strain curve that will be set as simulation conditions for acquiring the first waveform AW1. The second curve SC2 corresponds to a stress-strain curve that will be set as simulation conditions for acquiring the second waveform AW2.

As described above, the stress-strain curve is used as the simulation conditions in the shock simulation. In other words, it can also be said that the acceleration waveform and the shock response spectrum are calculated based on the stress-strain curve. The shock response spectrum is calculated based on the acceleration waveform. Note that, in contrast to the shock simulation, it is also possible to calculate the stress-strain curve based on the acceleration waveform. Specifically, for example, based on a certain acceleration waveform and simulation conditions other than the stress-strain curve, a stress-strain curve can be back calculated using a similar analysis algorithm as the shock simulation. In other words, the stress-strain curve that can be acquired in this way corresponds to the stress-strain curve that will be set as the simulation conditions for obtaining that acceleration waveform. On the other hand, in the related art, it is difficult to back-calculate the acceleration waveform based on the shock response spectrum. The reason for this is that the shock response spectrum is data that plots only the maximum acceleration for each natural frequency and that is more discrete data compared to the acceleration waveform. In the related art, when designing a cushioning material using a stress-strain curve, it is relatively easy to calculate the stress-strain curve after determining the shape, dimensions, and the like of the cushioning material, but it is relatively difficult to back-calculate the shape and dimensions of the cushioning material from a certain stress-strain curve.

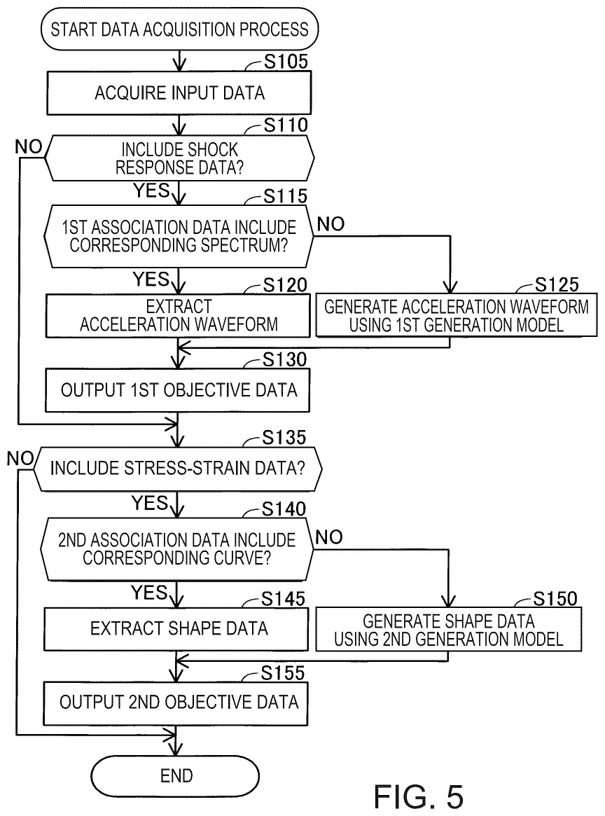

FIG. 5 is a flowchart of data acquisition process that realizes the data acquisition method according to the present embodiment. For example, whenever input data is entered into the data acquisition device 100 via the input device 106, the processor 101 starts the data acquisition process shown in FIG. 5.

In step S105, the input data acquisition section 110 acquires input data that has been entered via the input device 106. In other words, in step S105, at least one of shock response data and stress-strain data is acquired. The step of acquiring the input data as in step S105 is also referred to as a first step.

In step S110, the input data acquisition section 110 determines whether the shock response data is included in the input data acquired in step S105. If no shock response data is included in the input data in step $110, the input data acquisition section 110 proceeds to step S135.

If the shock response data is included in the input data in step S110, the objective data acquisition section 120 executes a first acquisition process in steps S115 to S125. In this embodiment, steps S115 to S125 correspond to a first acquisition step. The first acquisition step is a step for acquiring the first objective data using the first association data 161.

In the first acquisition process in the present embodiment, first, in step S115, the objective data acquisition section 120 determines, by referring to the first association data 161 based on the shock response data acquired in step S105, whether a corresponding spectrum is included in the first association data 161. The corresponding spectrum is a shock response spectrum corresponding to the shock response data acquired in the first step.

Specifically, the corresponding spectrum is a shock response spectrum where a first difference with respect to the shock response data is equal to or less than a predetermined first reference. The first difference is represented by, for example, a sum of squares of the differences in maximum acceleration, a square root of sum of squares of the differences in maximum acceleration, or an arithmetic mean value of these. The first difference may also be represented, for example, as a value that takes into account positions of peaks or number of peaks in the shock response data or the shock response spectrum. In this case, the first difference is defined, for example, so that the more approximate the positions or number of peaks are, the smaller the value will be.

If the corresponding spectrum is included in the first association data 161 in step S115, the objective data acquisition section 120 extracts, in step S120, an acceleration waveform associated with the corresponding spectrum from the first association data 161. The objective data acquisition section 120 acquires the extracted acceleration waveform as the first objective data. Note that when a plurality of corresponding spectra are included in the first association data 161, the objective data acquisition section 120 may, for example, extract an acceleration waveform associated with the corresponding spectrum with the smallest first difference, or the objective data acquisition section 120 may, randomly or based on predefined selection criteria, select one corresponding spectrum from the plurality of corresponding spectra and may extract an acceleration waveform associated with the selected corresponding spectrum. The objective data acquisition section 120 may also extract each acceleration waveform associated with a plurality of corresponding spectra as the first objective data.

If the corresponding spectrum is not included in the first association data 161 in step S115, in step S125, the objective data acquisition section 120 generates an acceleration waveform using the first generation model 171. Specifically, in step S125, the objective data acquisition section 120 inputs the shock response data acquired in step S105 to the first generation model 171, and generates an acceleration waveform corresponding to that shock response data. The objective data acquisition section 120 acquires the generated acceleration waveform as the first objective data.

In step S130, the objective data acquisition section 120 outputs the first objective data acquired in step S120 or step S125 by using the output device 105. Note that in step S130, for example, the first difference that was calculated in step S115 may be output together with the first objective data.

When designing cushioning materials, the user can use the acceleration waveform acquired as the first objective data in steps S120 and S125, or can refer to the output result of step S130. Note that, as described above, it is possible to calculate the stress-strain curve based on the acceleration waveform acquired as the first objective data in steps S120 or S125. By using the stress-strain curve calculated in this way, a cushioning material having desired protection performance can be designed more easily. Specifically, for example, shock response data that suppresses damage or breakage of each component included in the product as the protection target is entered as input data, an acceleration waveform corresponding to the shock response data is acquired in the first acquisition step, and then a stress-strain curve can be calculated based on the acquired acceleration waveform. In this way, a cushioning material with such protection performance that can suppress damage or breakage of each component included in the protection target can be designed more simply using the acquired stress-strain curve. Note that shock response data that suppresses damage or breakage for each component included in the protection target can be prepared, for example, by setting the maximum acceleration value of the shock response data based on a damage boundary curve (DBC). The damage boundary curve is acquired, for example, based on a simulation or an experiment to analyze a drop impact for the protection target.

In step S135, the input data acquisition section 110 determines whether the stress-strain data is included in the input data acquired in step S105. If the stress-strain data is not included in the input data in step S135, the input data acquisition section 110 terminates the data acquisition process.

If the stress-strain data is included in the input data in step S135, the objective data acquisition section 120 executes the second acquisition process in steps S140 to S150. In the present embodiment, steps S140 to S150 correspond to a second acquisition step. The second acquisition step is a step for acquiring the second objective data using the second association data 162. Note that the process of executing at least one of the first acquisition step and the second acquisition step is also referred to as the second step.

In the second acquisition process in the present embodiment, first, in step S140, the objective data acquisition section 120 determines whether a corresponding curve is included in the second association data 162 by referring to the second association data 162 based on the stress-strain data acquired in step S105. The corresponding curve is a stress-strain curve that corresponds to the stress-strain data acquired in the first step.

Specifically, the corresponding curve is a stress-strain curve where a second difference with respect to the stress-strain data is equal to or less than a predetermined second reference. The second difference is represented by, for example, a sum of squares of the differences in stress, a square root of sum of squares of the differences in stress, or an arithmetic mean value of these. The second difference may be a degree to which the stress-strain data or positions of peaks or number of peaks in the stress-strain curve are taken into account. In this case, the second difference is defined, for example, so that the more approximate the positions or number of peaks are, the smaller the value will be.

If the corresponding curve is included in the second association data 162 in step S140, the objective data acquisition section 120 extracts shape data associated with the corresponding curve from the second association data 162 in step S145. The objective data acquisition section 120 acquires the extracted shape data as the second objective data. Note that when a plurality of corresponding curves are included in the second association data 162, the objective data acquisition section 120 may, for example, extract shape data associated with the corresponding curve with the smallest second difference, or the objective data acquisition section 120 may, randomly or based on predefined selection criteria, select one corresponding curve from the plurality of corresponding curves and extract an acceleration waveform associated with the selected corresponding curve. The objective data acquisition section 120 may, for example, also extract each set of shape data associated with a plurality of corresponding curves as the second objective data.

If the corresponding curve is not included in the second association data 162 in step S140, the objective data acquisition section 120 generates shape data using the second generation model 172 in step S150. Specifically, in step S150, the objective data acquisition section 120 inputs the stress-strain response data acquired in step S105 to the second generation model 172, and generates shape data corresponding to that stress-strain data. The objective data acquisition section 120 acquires the generated shape data as the second objective data.

In step S155, the objective data acquisition section 120 outputs the second objective data acquired in step S145 or step $150 by using the output device 105. Note that in step S155, for example, the second difference that was calculated in step S140 may be output together with the second objective data.

When designing the cushioning material, the user can use the shape data acquired as the second objective data in steps S145 and S150, or can refer to the output result in step S155. In this way, when designing the cushioning material, in particular, the shape and dimensions of the cushioning material can be determined more simply.

Note that the stress-strain data included in the input data that is acquired in step S105 may be data relating to the stress-strain curve that was calculated based on the acceleration waveform as the first objective data. In this way, based on the desired shock response data, it is possible to acquire the shape data of the cushioning material that has protection performance to realize the behavior represented in the shock response data. By using the shape data acquired in this way, a cushioning material having desirable protection performance can be designed more simply.

According to the data acquisition method in the present embodiment described above, at least one of the first acquisition step that acquires the acceleration waveform corresponding to the shock response data as the first objective data using the first association data 161 that is associated with an acceleration waveform and a shock response spectrum, and the second acquisition step that acquires the shape data corresponding to the stress-strain data as the second objective data using the second association data 162 that is associated with shape data and a stress-strain curve is executed. In this way, the acceleration waveform corresponding to the desired shock response data and the shape data corresponding to the desired stress-strain data can be acquired as the objective data, and the cushioning material can be designed using the acquired acceleration waveform and shape data. Therefore, the desired cushioning material can be designed more simply.

In the present embodiment, in the first acquisition step, the corresponding spectrum is extracted from the first association data 161, and the extracted corresponding spectrum is acquired as the first objective data. In the second acquisition step, the corresponding curve is extracted from the second association data 162, and the extracted corresponding curve is acquired as the second objective data. Therefore, the first objective data and second objective data can be easily acquired by extracting them from the first association data 161 and second association data 162.

In this embodiment, in the first acquisition step, the first objective data is acquired by generating an acceleration waveform corresponding to the shock response data using the first generation model 171 that was subjected to machine learning using the first association data 161. Specifically, in the present embodiment, in the first acquisition step, if the corresponding spectrum is not included in the first association data 161, the first objective data is acquired by generating an acceleration waveform corresponding to the shock response data using the first generation model 171. In the second acquisition step, the second objective data is acquired by generating shape data corresponding to the stress-strain data using the second generation model 172 that was subjected to machine learning using the second association data 162. Specifically, in the present embodiment, in the second acquisition step, if the corresponding spectrum is not included in the second association data 162, the second objective data is acquired by generating shape data corresponding to the stress-strain data using the second generation model 172. In this way, even in a case where the shock response spectrum corresponding to the desired impact data is not included in the first association data 161 or in a case where the stress-strain curve corresponding to the desired stress-strain data is not included in the second association data 162, it is possible to acquire the first objective data or the second objective data by generating the first objective data or the second objective data. Therefore, it is possible to more reliably acquire the first objective data and the second objective data.

### B. Second Embodiment

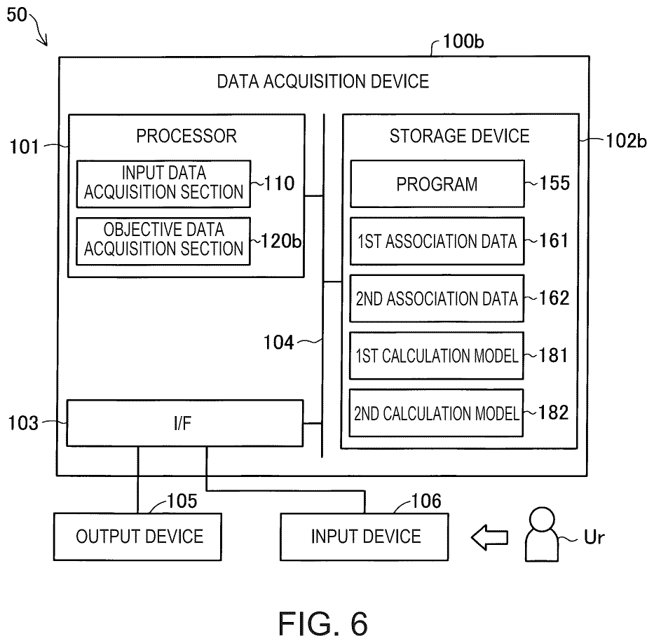

FIG. 6 is a block diagram showing a schematic configuration of a data acquisition device 100b in a second embodiment. Unlike the first embodiment, in the present embodiment, a storage device 102b of the data acquisition device 100b does not store the first generation model 171 and the second generation model 172, but stores a first calculation model 181 and a second calculation model 182. The configurations of the data acquisition device 100b and the design system 50 in the second embodiment are the same as those in the first embodiment unless otherwise specified.

The first calculation model 181 is a machine learning model that was subjected to machine learning using the acceleration waveform of the protection target and the shock response spectrum corresponding to that acceleration waveform as learning data. The first calculation model 181 is used to calculate a first similarity. The first similarity is a similarity between the shock response data that was input to the first calculation model 181 and the shock response spectrum that is included in the first association data 161. Hereinafter, the learning data that is used to train the first calculation model 181 is also referred to as third learning data.

As the first calculation model 181, for example, a machine learning model that extracts a feature value of the shock response data or of the shock response spectrum that was input to the first calculation model 181 can be used. The first similarity is calculated by comparing a feature value that is extracted by inputting the shock response data to the first calculation model 181 with a feature value that is extracted by inputting the shock response spectrum to the first calculation model 181. In this case, for example, the first similarity may be calculated by comparing the Euclidean distance, the Manhattan distance, or the Hamming distance between the feature values, or may be calculated by comparing feature value vectors representing these feature values. As the feature value of the shock response data or the shock response spectrum, for example, a feature value indicating an inclination of, a minimum value of, or a maximum value of the maximum acceleration, a feature value indicating a position of a peak, or a feature value indicating a number of peaks may be extracted.

As the first calculation model 181 for extracting the feature value of the shock response data or the shock response spectrum, for example, a part of layer structure of the CNN, which has been taught a correspondence relationship between acceleration waveforms and shock response spectra by supervised learning using the third learning data, can be used. Specifically, as the first calculation model 181, for example, of the layer structure of the CNN that has been trained using the third learning data, a layer structure up to the fully connected layer that is lower than the output layer can be used. In this case, the third learning data is, for example, training data that includes a plurality of shock response spectra as training data and that includes acceleration waveforms corresponding to each shock response spectrum as a ground truth label. For example, the first association data 161 may be used as the third learning data. As the first calculation model 181, a part of the structure of machine learning model similar to the first generation model 171 may be used. Note that in other embodiments, the first calculation model 181 may be configured, for example, by a neural network other than the CNN, or may be configured by an SVM or a decision tree. The first calculation model 181 is not limited to one trained by supervised learning, but may be one trained by unsupervised learning or reinforcement learning, for example.

The second calculation model 182 is a machine learning model that was subjected to machine learning using shape data of cushioning materials and stress-strain curves of these cushioning materials as learning data. The second calculation model 182 is used to calculate a second similarity. The second similarity is a similarity between the stress-strain data that was input to the second calculation model 182 and the stress-strain curve that is included in the second association data 162. Hereinafter, the learning data for learning the second calculation model 182 is also referred to as fourth learning data.

As the second calculation model 182, for example, a machine learning model that extracts a feature value of stress-strain data or a stress-strain curve that was input to the second calculation model 182 can be used. The second similarity is calculated by comparing feature values in the similar way as the first similarity. As the feature value of the stress-strain data or the stress-strain curve, for example, a feature value representing a slope of, minimum value of, or maximum value of the stress, a feature value representing positions of peaks, or a feature value representing a number of peaks can be extracted. As the second calculation model 182 of the stress-strain data or the stress-strain curve, for example, a part of layer structure of the CNN, which has been taught a correspondence relationship between shape data and the stress-strain by supervised learning using the fourth learning data, can be used. Specifically, as the second calculation model 182, for example, of the layer structure of the CNN that has been taught using the fourth learning data, a layer structure up to the fully connected layer that is lower than the output layer can be used. In this case, the fourth learning data is, for example, training data that includes stress-strain curves of the cushioning materials as the training data and that includes shape data of that cushioning materials as a ground truth label. The second association data 162 may be used as the fourth learning data, for example. As the second calculation model 182, a part of structure of the machine learning model similar to the second generation model 172 may be used. Note that in other embodiments, the second calculation model 182 may be configured, for example, by a neural network other than the CNN, or may be configured by an SVM or a decision tree. The second calculation model 182 is not limited to one trained by supervised learning, and may be one trained by unsupervised learning or reinforcement learning, for example.

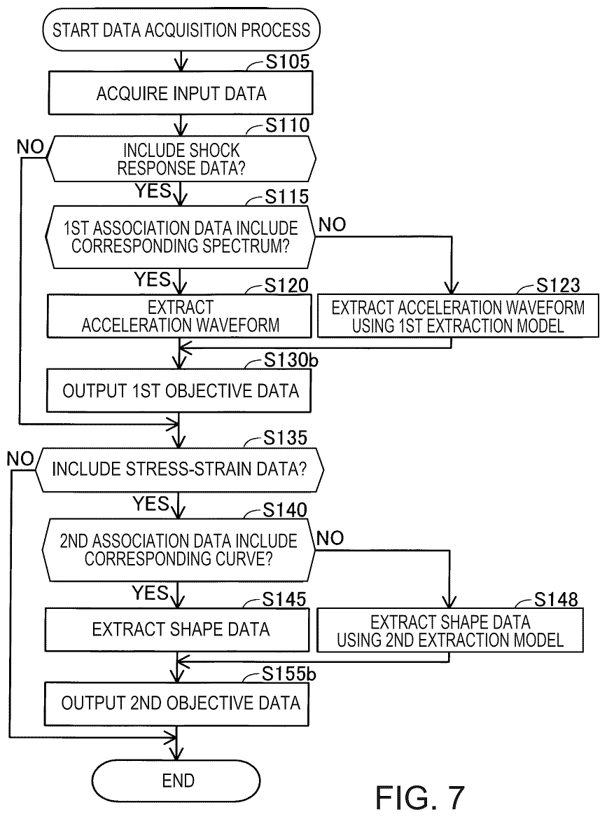

FIG. 7 is a flowchart of data acquisition process that realizes the data acquisition method according to the second embodiment. In FIG. 7, steps similar to those in FIG. 5 are denoted by the same reference numerals as those in FIG. 5.

In the present embodiment, if the corresponding spectrum is not included in the first association data 161 in step S115, in step S123, an objective data acquisition section 120b extracts an acceleration waveform from the first association data 161 according to the first similarity using the first calculation model 181. The objective data acquisition section 120b acquires the extracted acceleration waveform as the first objective data.

Specifically, in step S123, the objective data acquisition section 120b extracts an acceleration waveform that is associated with a shock response spectrum whose first similarity is equal to or greater than a predetermined similarity from the first association data 161. In step S123, first, the objective data acquisition section 120b calculates a first similarity using the first calculation model 181. Next, the objective data acquisition section 120b specifies, among the shock response spectra included in the first association data 161, a similarity spectrum, which is a shock response spectrum whose first similarity is greater than or equal to a predetermined first threshold. Then, the objective data acquisition section 120b acquires the first objective data by extracting an acceleration waveform associated with the specified similarity spectrum as the first objective data. In the present embodiment, among the shock response spectra whose first similarity is greater than or equal to a predetermined first threshold, a shock response spectrum with the highest first similarity is specified as the similarity spectrum. Note that in other embodiments, for example, a plurality of shock response spectra whose first similarities are greater than or equal to the first threshold may be specified as the similarity spectrum.

In step S130b, the objective data acquisition section 120b outputs the first objective data, that is, the acceleration waveform extracted in step S120 or step S123 by using the output device 105. Note that in step S130b, for example, the first similarity calculated in step S123 may be output together with the first objective data.

If the corresponding curve is not included in the second association data 162 in step S140, in step S148, the objective data acquisition section 120b extracts, using the second calculation model 182, shape data from the second association data 162 according to the second similarity. Specifically, in step S148, the objective data acquisition section 120b extracts the shape data that is associated with a stress-strain curve whose second similarity is greater than or equal to a predetermined similarity from the second association data 162. In step S148, the objective data acquisition section 120b, first, calculates the second similarity using the second calculation model 182. Next, the objective data acquisition section 120b specifies, among the stress-strain curves included in the second association data 162, a similar curve that is a stress-strain curve whose second similarity is greater than or equal to a predetermined second threshold. Then, the objective data acquisition section 120b acquires the second objective data by extracting the shape data associated with the specified similarity curve as the second objective data. In the present embodiment, among the stress-strain curves whose second similarity is greater than or equal to the predetermined second threshold, the stress-strain curve with the highest second similarity is specified as the similar curve. Note that in other embodiments, for example, each stress-strain curve whose second similarity is greater than or equal to the second threshold may be specified as the similar curve.

In step S155b, the objective data acquisition section 120b outputs the second objective data, that is, the shape data that was extracted in step S145 or step S148 by using the output device 105. Note that in step S155b, for example, the second similarity calculated in step S148 may be output together with the second objective data.

According to the data acquisition method in the second embodiment described above, in the first acquisition step, the first similarity is calculated using the first calculation model 181, which has been subjected to machine learning using the acceleration waveform and the shock response spectrum as learning data, then by extracting the acceleration waveform associated with the shock response spectrum whose first similarity is greater than or equal to the predetermined similarity from the first association data 161, the first objective data is acquired. Specifically, in the present embodiment, in the first acquisition step, if the corresponding spectrum is not included in the first association data 161, the first objective data is acquired by extracting the acceleration waveform using the first calculation model 181. In the second acquisition step, the second similarity is calculated using the second calculation model 182, which has been subjected to machine learning using the shape data and the stress-strain curves as learning data, then by extracting shape data associated with the stress-strain curve whose second similarity is greater than or equal to the predetermined similarity from the second association data 162, the second objective data is acquired. Specifically, in the present embodiment, in the second acquisition step, if the corresponding spectrum is not included in the second association data 162, the second objective data is acquired by extracting the shape data using the second calculation model 182. In this way, even if the corresponding spectrum is not included in the first association data 161 or the corresponding curve is not included in the second association data 162, the first objective data and the second objective data can be acquired, by extracting, using the first calculation model 181 and the second calculation model 182. Therefore, it is possible to more reliably acquire the first objective data and the second objective data.

### C. Third Embodiment

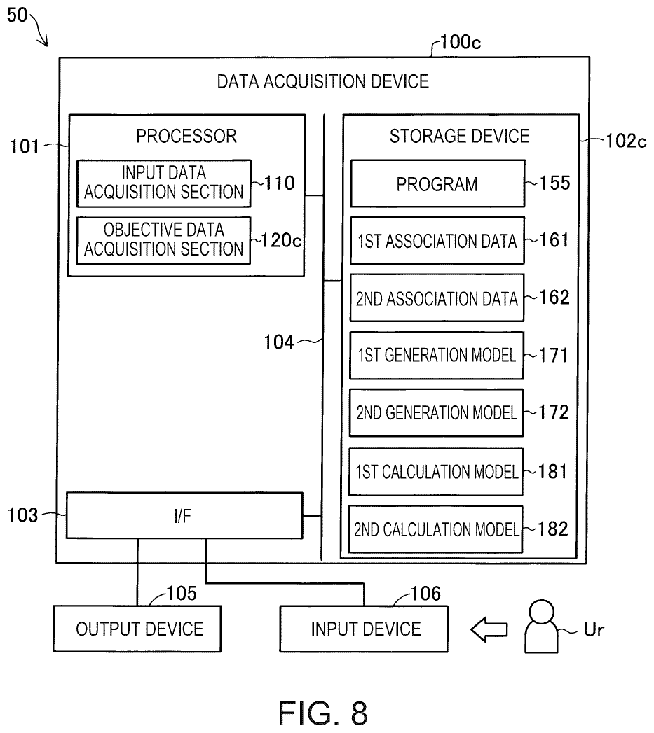

FIG. 8 is a block diagram showing a schematic configuration of a data acquisition device 100c in a third embodiment. Unlike the first embodiment, in the present embodiment, the storage device 102c of the data acquisition device 100c stores not only the first generation model 171 and the second generation model 172 but also the first calculation model 181 and the second calculation model 182. The configurations of the data acquisition device 100c and the design system 50 in the third embodiment are the same as those in the first embodiment unless otherwise specified.

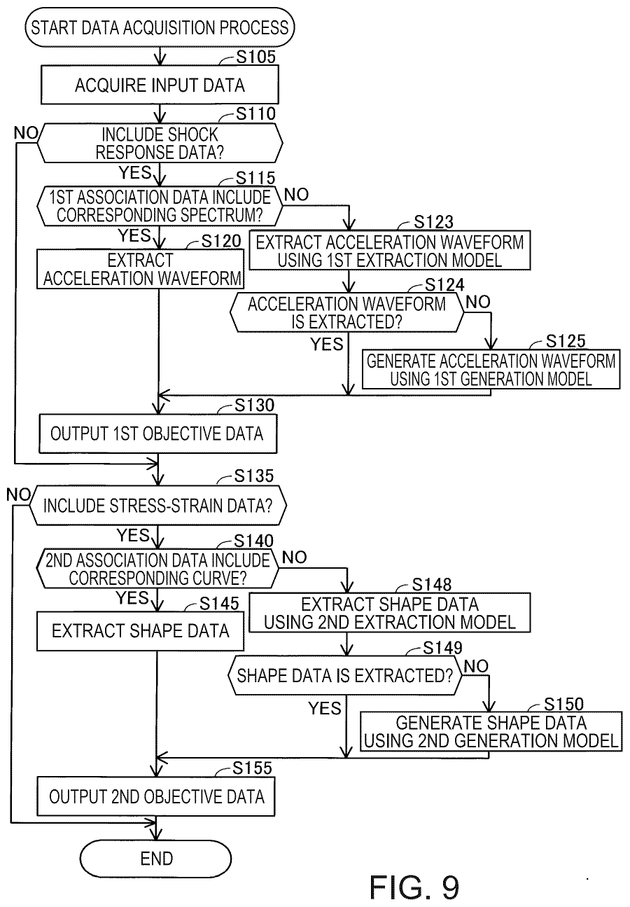

FIG. 9 is a flowchart of data acquisition process that realizes the data acquisition method according to the third embodiment. In FIG. 9, steps similar to those in FIGS. 5 and 7 are denoted by the same reference numerals as those in FIGS. 5 and 7.

After step S123 has been executed, in step S124, an objective data acquisition section 120c determines whether the acceleration waveform has been extracted in step S123. If it is determined that the acceleration waveform has been extracted in step S124, the objective data acquisition section 120c proceeds to step S130c. If it is determined that the acceleration waveform has not been extracted in step S124, in step S125, the objective data acquisition section 120c generates the acceleration waveform using the first generation model 171, and acquires the generated acceleration waveform as the first objective data. In other words, in the present embodiment, a first correspondence process that acquires an acceleration waveform associated with the corresponding spectrum, a first similarity process that acquires an acceleration waveform associated with the similarity spectrum, and a first generation process that acquires an acceleration waveform generated by the first generation model 171 are executed in this priority order. Note that a case where the acceleration waveform is not extracted in step S123, specifically, corresponds to a case where the similarity spectrum is not included in the first association data 161. In step S130c, the objective data acquisition section 120c outputs the first objective data, that is, the acceleration waveform extracted in step S120 or in step S123, or the acceleration waveform generated in step S125, by using the output device 105.

After step S148 has been executed, in step S149, the objective data acquisition section 120c determines whether shape data has been extracted in step S148. If it is determined that the shape data has been extracted in step S149, the objective data acquisition section 120c proceeds to step S155c. If it is determined that the shape data has not been extracted in step S149, in step S150, the objective data acquisition section 120c generates the shape data using the second generation model 172 and acquires the generated shape data as the second objective data. In other words, in the present embodiment, a second correspondence process that acquires shape data associated with the corresponding curve, a second similarity process that acquires shape data associated with the similarity curve, and a second generation process that acquires shape data generated by the second generation model 172 are executed in this priority order. Note that a case where the shape data is not extracted in step S148 corresponds, specifically, to a case where the similar curve is not included in the second association data 162. In step S155c, the objective data acquisition section 120c outputs the second objective data, that is, the shape data extracted in step S145 or step S148, or the shape data generated in step S150, by using the output device 105.

According to the data acquisition method in the third embodiment described above, in the first acquisition step, in a case where the corresponding spectrum and the similarity spectrum are not included in the first association data 161, by generating the acceleration waveform using the first generation model 171, the first objective data is acquired. In the second acquisition step, in a case where the corresponding curve and the similar curve are not included in the second association data 162, by generating the shape data using the second generation model 172, the second objective data is acquired. Therefore, it is possible to more reliably acquire the first objective data and the second objective data.

### D. Fourth Embodiment

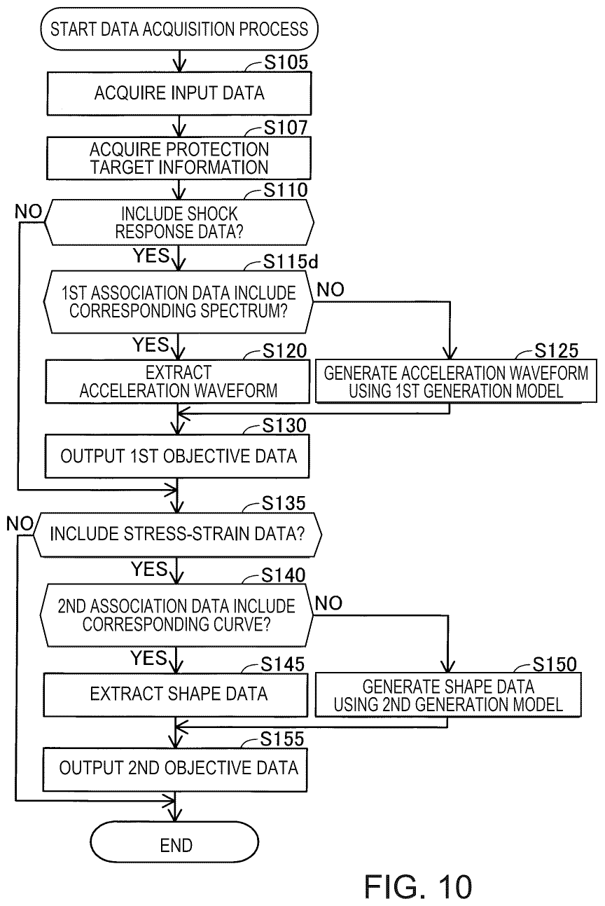

FIG. 10 is a flowchart of data acquisition process that realizes a data acquisition method according to a fourth embodiment. In FIG. 10, the same steps as those in FIG. 5 are denoted by the same reference numerals as those in FIG. 5. In this embodiment, unlike the first embodiment, step S107 is executed. In addition, in step S115d, according to a first range (to be described later), it is determined whether a first corresponding spectrum is included in the first association data 161. The configurations of the data acquisition device 100 and the design system 50 in the fourth embodiment are the same as those in the first embodiment unless otherwise specified.

In step S107, the input data acquisition section 110 acquires protection target information. In the present embodiment, the protection target information is type information representing a type of the protection target. For example, if the protection target is a printing device, in step S107, the type information indicating that the protection target is a printing device is acquired. Note that in the present embodiment, the protection target information is acquired based on designation by the user via the input device 106. In other embodiments, the protection target information may include, for example, in addition to or instead of the type information, information indicating the dimensions or mass of the protection target.

The corresponding spectrum in the present embodiment is defined as a shock response spectrum whose first difference is around the first reference in the first range, which is a predetermined frequency range. Therefore, in step S115d, the objective data acquisition section 120 determines whether the shock response spectrum whose first difference in the first range is equal to or less than the first reference is included in the first association data 161. The first range is defined according to the protection target. Specifically, the first range is determined based on the protection target information acquired in step S107. In other words, in the present embodiment, the first range is determined based on designation by the user. Note that if the protection target is office equipment, the cushioning material is generally designed to reduce acceleration around 200 Hz. Therefore, if the protection target is office equipment, it is desirable that the first range is set to include the natural frequency of 200 Hz.

In step S115d, the first range is acquired, for example, based on the protection target information acquired in step S107, by referring to a range database in which the protection target information and the first range are associated. For example, the range database may be stored in the storage device 102, or may be stored in a computer or a recording medium outside the data acquisition device 100.

According to the data acquisition method of the fourth embodiment described above, the corresponding spectrum is the shock response spectrum whose first difference is equal to or less than the first reference in the first range, which is the frequency range determined according to the protection target. Therefore, by defining an appropriate first range for each protection target, it is possible to acquire appropriate first objective data according to the protection target.

In the present embodiment, the first range is determined based on the designation by the user. Therefore, it is possible to acquire appropriate first objective data according to a desired protection target using a simple method.

### E. Fifth Embodiment

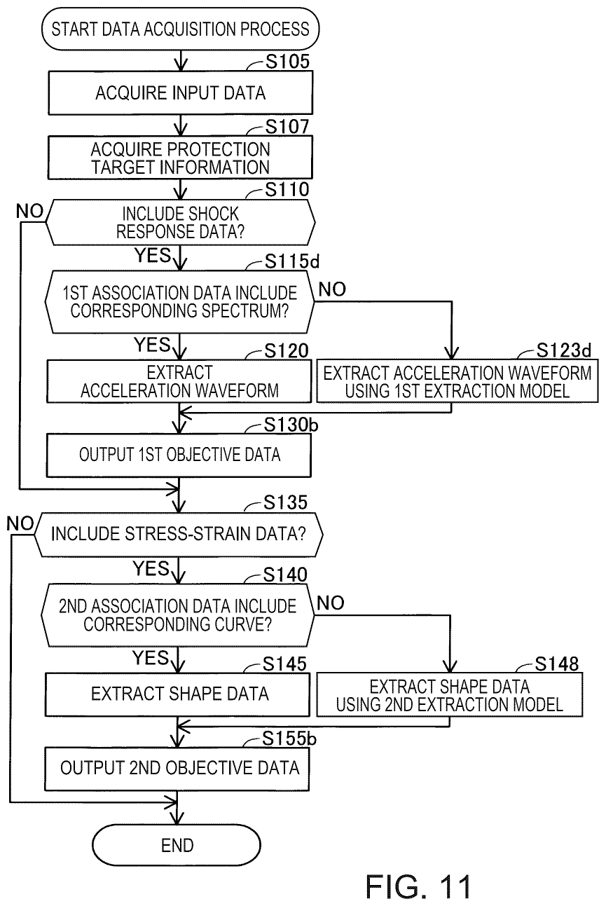

FIG. 11 is a flowchart of data acquisition process that realizes a data acquisition method according to a fifth embodiment. In FIG. 11, the same steps as those in FIGS. 5, 7, and 10 are denoted by the same reference numerals as those in FIGS. 5, 7, and 10. In the present embodiment, step S107 and step S115b are executed as in the fourth embodiment. In the present embodiment, unliked the first embodiment and the fourth embodiment, in step S123d, it is determined whether the first similarity spectrum is included in the first association data 161 according to a second range described below. The configurations of the data acquisition device 100 and the design system 50 in the fifth embodiment are the same as those in the first embodiment unless otherwise specified.

In step S123d, the objective data acquisition section 120 calculates a first similarity in the second range, which is a predetermined frequency range. In the present embodiment, in step S123d, the objective data acquisition section 120 determines the first similarity by comparing maximum acceleration of the shock response data in the second range with maximum acceleration of shock response spectrum, which is included in the first association data 161, in the second range. The second range is defined according to the protection target. In this embodiment, the second range is defined by the protection target information in the same manner as the first range. In other words, in the present embodiment, the second range is determined based on designation by the user. The second range in this embodiment is the same frequency range as the first range.

Specifically, in step S123d, the second range is acquired, for example, in substantially the same manner as the first range, by referring to the range database in which the protection target information and the second range are associated. In addition, in step S123d, the objective data acquisition section 120 inputs data, among the shock response data acquired in step S105, that is in the second range and data, among the shock response spectra included in the first association data 161, that is in the second range to the first calculation model 181. By this, a feature value of the shock response data in the second range and a feature value of the shock response spectrum in the second range are extracted. The extracted feature values are compared with each other to calculate a first similarity in the second determination range.

According to the data acquisition method in the fifth embodiment described above, in the first acquisition step, the first calculation model 181 calculates the first similarity in the predetermined second range according to the protection target. Therefore, it is possible to increase the possibility of acquiring more appropriate first objective data according to the first similarity.

In the present embodiment, the second range is determined based on the designation by the user. Therefore, it is possible to increase the possibility of acquiring appropriate first objective data according to a desired protection target using a simple method.

### F. Other Embodiments

(F-1) In each of the above embodiments, the input data includes the shock response data and the stress-strain data, but the input data may include at least one of the shock response data and the stress-strain data.

(F-2) In each of the above embodiments, the second step includes the first acquisition step and the second acquisition step, but the second step may include at least one of the first acquisition step and the second acquisition step.

(F-3) In each of the above embodiments, in the first acquisition step, only one of the first correspondence process, the first similarity process and the first generation process may be executed, only any two of these processes may be executed, or three processes may be executed. When two or three processes are executed, the priority order in which each process is executed may be arbitrary. For example, in the first embodiment above, the first correspondence process is preferentially executed over the first generation process, but the first generation process may be preferentially executed over the first similarity process. In the second embodiment, the first correspondence process is preferentially executed over the first similarity process, but the first similarity process may be preferentially executed over the first correspondence process. In addition, the first similarity process may be preferentially executed over the first generation process, or the first generation process may be preferentially executed over the first similarity process. Note that in a case where the priority order of the first generation process is higher than that of the first correspondence process or the first similarity process, for example, an evaluation step that evaluates the acceleration waveform generated by the first generation process may be provided, and it may be determined, according to the evaluation result of the evaluation step, whether or not to execute the first correspondence process or the first similarity process. In this case, the evaluation in the evaluation step, for example, may be executed by receiving the evaluation result from the user that was input via the input device 106 or by using an evaluation model for executing the evaluation of the generated acceleration waveform.

(F-4) In each of the above embodiments, in the second acquisition step, only one of the second correspondence process, the second similarity process, and the second generation process may be executed, only any two of these processes may be executed, or three processes may be executed. When two or three processes are executed, the priority order in which each process is executed may be arbitrary. For example, in the first embodiment above, the second correspondence process is preferentially executed over the second generation process, but the second generation process may be preferentially executed over the second similarity process. In the second embodiment, the second correspondence process is preferentially executed over the second similarity process, but the second similarity process may be preferentially executed over the second correspondence process. The second similarity process may be preferentially executed over the second generation process, or the second generation process may be preferentially executed over the second similarity process. Note that in a case where the priority order of the second generation process is higher than that of the second correspondence process or the second similarity process, for example, an evaluation step that evaluates the shape data generated by the second generation process may be provided, and it may be determined, according to the evaluation result of the evaluation step, whether or not to execute the second correspondence process or the second similarity process. In this case, the evaluation in the evaluation step, for example, may be executed by receiving the evaluation result from the user that was input via the input device 106 or by using an evaluation model for executing the evaluation of the generated acceleration waveform.

(F-5) In each of the above embodiments, the first similarity is calculated using the first calculation model 181, which is a machine learning model that has been subjected to machine learning using a plurality of acceleration waveforms and a plurality of shock response spectra as learning data. However, the first similarity may be calculated, for example, using a machine learning model that has been subjected to machine learning using a plurality of shock response spectra as learning data. Also in this case, as the machine learning model for calculating the first similarity, for example, a machine learning model that extracts feature values of the shock response data and the shock response spectra can be used. The first similarity may be calculated without using a machine learning model. In this case, for example, the degree of similarity may be calculated by extracting the feature value of the shock response data or the feature value of the shock response spectrum by using a feature value extraction algorithm and then by comparing the extracted feature values. As the feature value extraction algorithm, for example, various algorithms such as accelerated KAZE (AKAZE), KAZE, Scale-Invariant Feature Transform (SIFT), and Oriented FAST and Rotated BRIEF (ORB) can be used. Similarly, the second similarity may be calculated without using a machine learning model.

(F-6) In the fourth and the fifth embodiments above, the first range, which is the frequency range in which the first correspondence process is executed, and the second range, which is the frequency range in which the first similarity process is executed, are determined according to the protection target. However, the frequency range in which the first correspondence process is executed or the frequency range in which the first similarity process is executed need not be determined according to the protection target. For example, they may be determined simply based on designation by the user. In this case, for example, the user may input a numerical value representing the first range or the second range to the data acquisition device 100 via the input device 106.

(F-7) In the fourth and the fifth embodiments above, the first range, which is a frequency range in which the first correspondence process is executed, and the second range, which is a frequency range in which the first similarity process is executed, are determined based on designation by the user. However, the vibration frequency range in which the first correspondence process is executed or the vibration frequency range in which the first similarity process is executed may not be determined based on the designation by the user. For example, they may be acquired by analyzing the shock response data included in the input data.

(F-8) In each of the above embodiments, the cushioning material CM is designed as a cushioning material that protects the protection target from shock due to falling. However, for example, it may be designed as a cushioning material that protects the protection target from shocks of any type other than falling, such as shocks caused by collisions with any object or shocks caused by vibration.

### G. Other Forms

The present disclosure is not limited to the above described embodiments and can be realized in various forms without departing from the spirit thereof. For example, the present disclosure can also be realized by the following aspects. The technical features in the above described embodiments corresponding to the technical features in each aspect described below can be appropriately replaced or combined in order to solve a part or all of the problems of the present disclosure or in order to achieve a part or all of the effects of the present disclosure. If the technical features are not described as essential in this specification, the technical features can be appropriately deleted.

(1) According to a first aspect of the present disclosure, a data acquisition method is provided. This data acquisition method includes a first step for acquiring input data including at least one of shock response data that relates to a shock response spectrum and stress-strain data that relates to a stress-strain curve, and a second step for executing at least one of (i) a first acquisition step for acquiring, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition step for acquiring, using second association data in which shape data of the cushioning material and the stress-strain curve of the cushioning material are associated, second objective data representing the shape data corresponding to the input stress-strain data. According to this aspect, it is possible to acquire the acceleration waveform corresponding to desired shock response data or the shape data corresponding to desired stress-strain data as the objective data, and the cushioning material can be designed using the acquired acceleration waveform or shape data. Therefore, the desired cushioning material can be designed more simply.

(2) In the above aspect, in the first acquisition step, if the first association data includes corresponding spectrum, which is the shock response spectrum corresponding to the shock response data, the first objective data may be acquired by extracting the acceleration waveform that is associated with the corresponding spectrum from the first association data, and in the second acquisition step, if the second association data includes a corresponding curve, which is the stress-strain curve corresponding to the stress-strain data, the second objective data may be acquired by extracting the shape data that is associated with the corresponding curve from the second association data. According to this aspect, the first objective data and the second objective data can be easily acquired by extracting the corresponding spectrum and the corresponding curve from the first association data and the second association data.

(3) In the above aspects, the corresponding spectrum may be, in a predetermined frequency range according to the object, the shock response spectrum whose difference with respect to the shock response data is equal to or less than a predetermined level. According to this aspect, it is possible to increase the possibility of acquiring the appropriate first objective data according to the protection target.

(4) In the above embodiments, in the first acquisition step, by using a first calculation model that was subjected to machine learning using the acceleration waveform and the shock response spectrum as learning data, a first similarity, which is a degree of similarity between the shock response data that was input to a first calculation model and the shock response spectrum that is included in the first association data, may be calculated, and by extracting the acceleration waveform that is associated with the shock response spectrum whose first similarity is greater than or equal to a predetermined similarity from the first association data, the first objective data may be acquired, and in the second acquisition step, by using a second calculation model that was subjected to machine learning using the stress-strain data and the shape data as learning data, a second similarity, which is a degree of similarity between the stress-strain data that was input to the second calculation model and the stress-strain curve that is included in the second association data, may be calculated, and by extracting the shape data associated with the stress-strain curve whose second similarity is greater than or equal to a predetermined similarity from the second association data, the second objective data may be acquired. According to this mode, for example, even when the corresponding spectrum is not included in the first association data or the corresponding curve is not included in the second association data, the first objective data or the second objective data can be acquired by extracting the first objective data or the second objective data using the first calculation model or the second calculation model.

(5) In the above aspects, in the first acquisition step, the first similarity may be determined in a predetermined frequency range according to the object. According to this aspect, it is possible to increase the possibility of acquiring the appropriate first objective data according to the protection target.

(6) In the above aspects, the frequency range may be determined based on designation by the user. According to this aspect, it is possible to increase the possibility of acquiring the appropriate first objective data according to the desired protection target by a simple method.

(7) In the above aspects, in the first acquisition step, by generating the acceleration waveform corresponding to the shock response data using a first generation model that was subjected to machine learning using the first association data as learning data, the first objective data may be acquired, and in the second acquisition step, by generating the shape data corresponding to the stress-strain data using a second generation model that was subjected to machine learning using the second association data as learning data, the second objective data may be acquired. According to this aspect, for example, even in a case where the corresponding spectrum is not included in the first association data or a case where the corresponding curve is not included in the second association data, the first objective data or the second objective data can be acquired by generating the first objective data or the second objective data.

(8) In the above aspects, in the first acquisition step, if the shock response spectrum corresponding to the shock response data is not included in the first association data, by using a first calculation model that was subjected to machine learning using the acceleration waveform and the shock response spectrum as learning data, a first similarity, which is a degree of similarity between the shock response data that was input to a first calculation model and the shock response spectrum that is included in the first association data, may be calculated, and by extracting the acceleration waveform that is associated with the shock response spectrum whose first similarity is greater than or equal to a predetermined similarity from the first association data, the first objective data may be acquired, and in the second acquisition step, if the stress-strain curve corresponding to the stress-strain data is not included in the second association data, a second similarity, which is a degree of similarity between the stress-strain data that was input to the second calculation model and the stress-strain curve that is included in the second association data, is calculated by using a second calculation model that was subjected to machine learning using the stress-strain data and the shape data as learning data, and by extracting the shape data associated with the stress-strain curve whose second similarity is greater than or equal to a predetermined similarity from the second association data, the second objective data may be acquired. According to this aspect, it is possible to more reliably acquire the first objective data and the second objective data.

(9) In the above aspects, in the first acquisition step, if the shock response spectrum is not extracted by the first calculation model, by generating the acceleration waveform corresponding to the shock response data using a first generation model that was subjected to machine learning using the first association data as learning data, the first objective data may be acquired, and in the second acquisition step, if the stress-strain curve is not extracted by the second calculation model, by generating the shape data corresponding to the stress-strain data using a second generation model that was subjected to machine learning using the second association data as learning data, the second objective data may be acquired. According to this aspect, the first objective data and the second objective data can be acquired more reliably.

(10) In the above aspects, in the first acquisition step, if the shock response spectrum corresponding to the shock response data is not included in the first association data, by generating the acceleration waveform corresponding to the shock response data using a first generation model that was subjected to machine learning using the first association data as learning data, the first objective data may be acquired, and in the second acquisition step, if the stress-strain curve corresponding to the stress-strain data is not included in the second association data, by generating the shape data corresponding to the stress-strain data using a second generation model that was subjected to machine learning using the second association data as learning data, the second objective data may be acquired. According to this aspect, it is possible to more reliably acquire the first objective data and the second objective data.

(11) According to a second aspect of the present disclosure, a data acquisition device is provided. This data acquisition device includes an input data acquisition section that acquires input data including at least one of shock response data that relates to a shock response spectrum and stress-strain data that relates to a stress-strain curve; and an objective data acquisition section that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.

(12) According to a third aspect of the present disclosure, a non-transitory computer recording medium storing a program to be executed by a computer is provided. The program includes a function that acquires input data including at least one of shock response data that relates to a shock response spectrum and stress-strain data that relates to a stress-strain curve; and a function that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.

The present disclosure can be realized in an aspect of a cushioning material design system, a cushioning material design method, and the like in addition to the above aspects.

What is claimed is:

1. A data acquisition method comprising:
a first step for acquiring input data including at least one of shock response data that relates to a shock response spectrum and stress-strain data that relates to a stress-strain curve and
a second step for executing at least one of (i) a first acquisition step for acquiring, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition step for acquiring, using second association data in which shape data of the cushioning material and the stress-strain curve of the cushioning material are associated, second objective data representing the shape data corresponding to the input stress-strain data.

2. The data acquisition method according to claim 1, wherein
in the first acquisition step, if the first association data includes a corresponding spectrum, which is the shock response spectrum corresponding to the shock response data, the first objective data is acquired by extracting the acceleration waveform that is associated with the corresponding spectrum from the first association data and
in the second acquisition step, if the second association data includes a corresponding curve, which is the stress-strain curve corresponding to the stress-strain data, the second objective data is acquired by extracting the shape data that is associated with the corresponding curve from the second association data.

3. The data acquisition method according to claim 2, wherein
the corresponding spectrum is, in a predetermined frequency range according to the object, the shock response spectrum whose difference with respect to the shock response data is equal to or less than a predetermined level.

4. The data acquisition method according to claim 1, wherein
in the first acquisition step,
a first similarity, which is a degree of similarity between the shock response data that was input to a first calculation model and the shock response spectrum that is included in the first association data, is calculated by using a first calculation model that was subjected to machine learning using the acceleration waveform and the shock response spectrum as learning data and
the first objective data is acquired by extracting, from the first association data, the acceleration waveform that is associated with the shock response spectrum whose first similarity is greater than or equal to a predetermined similarity and
in the second acquisition step,
a second similarity, which is a degree of similarity between the stress-strain data that was input to the second calculation model and the stress-strain curve that is included in the second association data, is calculated by using a second calculation model that was subjected to machine learning using the stress-strain data and the shape data as learning data and
the second objective data is acquired by extracting, from the second association data, the shape data associated with the stress-strain curve whose second similarity is greater than or equal to a predetermined similarity.

5. The data acquisition method according to claim 4, wherein
in the first acquisition step, the first similarity is determined in a predetermined frequency range according to the object.

6. The data acquisition method according to claim 3, wherein
the frequency range is determined based on designation by the user.

7. The data acquisition method according to claim 1, wherein
in the first acquisition step, the first objective data is acquired by using a first generation model that was subjected to machine learning using the first association data as learning data to generate the acceleration waveform corresponding to the shock response data and
in the second acquisition step, the second objective data is acquired by using a second generation model that was subjected to machine learning using the second association data as learning data to generate the shape data corresponding to the stress-strain data.

8. The data acquisition method according to claim 2, wherein
in the first acquisition step, if the shock response spectrum corresponding to the shock response data is not included in the first association data,
a first similarity, which is a degree of similarity between the shock response data that was input to a first calculation model and the shock response spectrum that is included in the first association data, is calculated by using a first calculation model that was subjected to machine learning using the acceleration waveform and the shock response spectrum as learning data and
the first objective data is acquired by extracting, from the first association data, the acceleration waveform that is associated with the shock response spectrum whose first similarity is greater than or equal to a predetermined similarity and
in the second acquisition step, if the stress-strain curve corresponding to the stress-strain data is not included in the second association data,
a second similarity, which is a degree of similarity between the stress-strain data that was input to the second calculation model and the stress-strain curve that is included in the second association data, is calculated by using a second calculation model that was subjected to machine learning using the stress-strain data and the shape data as learning data and
the second objective data is acquired by extracting, from the second association data, the shape data associated with the stress-strain curve whose second similarity is greater than or equal to a predetermined similarity.

9. The data acquisition method according to claim 8, wherein
in the first acquisition step, if the shock response spectrum is not extracted by the first calculation model, the first objective data is acquired by using a first generation model that was subjected to machine learning using the first association data as learning data to generate the acceleration waveform corresponding to the shock response data and
in the second acquisition step, if the stress-strain curve is not extracted by the second calculation model, the second objective data is acquired by using a second generation model that was subjected to machine learning using the second association data as learning data to generate the shape data corresponding to the stress-strain data.

10. The data acquisition method according to claim 2, wherein
in the first acquisition step, if the shock response spectrum corresponding to the shock response data is not included in the first association data, the first objective data is acquired by using a first generation model that was subjected to machine learning using the first association data as learning data to generate the acceleration waveform corresponding to the shock response data and
in the second acquisition step, if the stress-strain curve corresponding to the stress-strain data is not included in the second association data, the second objective data is acquired by using a second generation model that was subjected to machine learning using the second association data as learning data to generate the shape data corresponding to the stress-strain data.

11. A data acquisition device comprising:
an input data acquisition section that acquires input data including at least one of shock response data that relates to a shock response spectrum and stress-strain data that relates to a stress-strain curve and
an objective data acquisition section that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.

12. A non-transitory computer recording medium storing a program to be executed by a computer,
the program comprising:
a function that acquires input data including at least one of shock response data that relates to a shock response spectrum and stress-strain data that relates to a stress-strain curve and
a function that executes at least one of (i) a first acquisition process that acquires, using first association data in which an acceleration waveform representing shock acceleration of an object that is protected by a cushioning material and the shock response spectrum of the object are associated, first objective data representing the acceleration waveform corresponding to the acquired shock response data and (ii) a second acquisition process that acquires, using second association data in which shape data of the cushioning material and the stress-strain curve of the cushioning material are associated, second objective data representing the shape data corresponding to the input stress-strain data.
